(19) United States
(12) Patent Application Publication
(10) Pub. No.: US 2022/0369864 A1
(43) Pub. Date: Nov. 24, 2022

(54) GRILL SHELL STRUCTURE FOR GRILL

(71) Applicant: NINGBO AGSUN PRODUCTS,INC., CIXI (CN)

(72) Inventors: Xuefei Mao, CIXI (CN); Jinsheng Wu, CIXI (CN); Xianghua Liu, CIXI (CN)

(73) Assignee: NINGBO AGSUN PRODUCTS,INC., CIXI (CN)

(21) Appl. No.: 17/878,942

(22) Filed: Aug. 2, 2022

(30) Foreign Application Priority Data
Jun. 27, 2022 (CN) 202221637841.X

(51) Int. Cl. A47J 37/12

(52) U.S. Cl. CPC A47J 37/1276

(57) ABSTRACT

The present disclosure provides a grill shell structure for a grill, which comprises an inner chamber, a heat insulation member is accommodated in the inner chamber, and the heat insulation member is fixed on a grill shell by a fixing structure. A support body is arranged between a side of the heat insulation member facing an inner wall of the inner chamber and the inner wall of the inner chamber for support so that the heat insulation member is arranged spatially apart from an inner wall of the grill shell to form a heat insulation chamber between the heat insulation member and the inner wall of the grill shell.

### TECHNICAL FIELD

The present disclosure pertains to the technical field of pellet stoves, and specifically pertains to a grill shell structure for a grill.

### BACKGROUND

A pellet grill is a barbecue grill heated by pellet burning. A conventional pellet grill generally comprises a grill shell, a chamber for pellet burning is provided in the grill shell, and a grilling net is provided above the chamber. Pellets burn in the chamber to generate heat, so that food placed on the grilling net is roasted to maturity. In order to make temperature in the grill chamber as uniform as possible, a fire distributing plate is arranged in the chamber to make the heat uniform. An ash falling pipe is provided at a bottom of the grill shell for discharging ash resulting from the pellet burning. However, the pellet burning temperature in the grill chamber is relatively high, especially around the ash falling pipe, and persistent high temperature will affect the grill shell, which will easily cause paint peeling and other phenomena on the grill shell.

### SUMMARY

The object of the present disclosure is to provide a grill shell structure for a grill in order to solve the above-mentioned technical deficiencies, which has the advantages of slowing down heat transfer and reducing temperature of the grill shell.

A grill shell structure for a grill provided by the present disclosure comprises a grill shell, the grill shell comprises an inner chamber, a heat insulation member is accommodated in the inner chamber, and the heat insulation member is fixed on the grill shell by a fixing structure; and a support body is arranged between a side of the heat insulation member facing an inner wall of the inner chamber and the inner wall of the inner chamber for support so that the heat insulation member is arranged spatially apart from an inner wall of the grill shell to form a heat insulation chamber between the heat insulation member and the inner wall of the grill shell.

In the present technical scheme, a support member is arranged between the heat insulation member and the inner wall of the inner chamber so that the heat insulation member is arranged in a spaced apart manner from the grill shell to separate burning pellets in the grill chamber from a bottom of the grill shell, and heat generated by pellet burning is conducted to the bottom of the grill shell through the heat insulation member. The heat insulation chamber between the heat insulation member and the grill shell can effectively slow down heat transfer, reduce temperature of the grill shell and extend service life of the grill shell.

Further, a first flange is formed on the heat insulation member at two opposite first edges; a second flange is formed on the heat insulation member at two opposite second edges; and the first flange and the second flange have a height of 10±1 mm, so that the height of the heat insulation chamber is 10±1 mm.

In the present technical scheme, at least one set of opposite edges of the heat insulation member can be provided with flanges which act as a support body, that is, the heat insulation member can be arranged spatially apart from the grill shell to form the heat insulation chamber.

Still further, the heat insulation member comprises a first plate body and a second plate body distributed symmetrically, and the heat insulation member is formed by splicing or integral molding of the first plate body and the second plate body. The heat insulation member in the present technical scheme can be a split type or integrated type to meet more usage requirements.

Still further, symmetrical first mounting holes are provided on the first plate body and the second plate body, and the fixing structure is connected to the grill shell through the first mounting holes, so that the heat insulation member is fixed on the grill shell.

Still further, a bottom of the grill shell is provided with an ash falling pipe, two notches corresponding to a position of the ash falling pipe are provided at a junction of the first plate body and the second plate body, the notches are symmetrically combined to form a perforation, and the ash falling pipe is arranged through the perforation. In the present technical scheme, the notches are provided so that the ash falling pipe can be arranged in a spaced apart manner, and the heat insulation member can be positioned and arranged in the grill shell through the notches and the ash falling pipe, resulting in more accurate and convenient mounting.

Still further, a fire distributing plate is also accommodated in the inner chamber, the fire distributing plate is arranged on the heat insulation member, symmetrical second mounting holes are provided on the first plate body and the second plate body for connecting the fire distributing plate, and the second mounting holes are elongated through holes; and the fire distributing plate is provided with elongated protrusions on both sides for connecting the heat insulation member, and the elongated protrusions of the fire distributing plate are inserted into the second mounting holes to connect the heat insulation member.

The arrangement of the fire distributing plate in the grill shell can balance heat resulting from pellet burning, so that food to be roasted is evenly heated, and the fire distributing plate is arranged on the heat insulation member through the elongated protrusions and the second mounting holes, resulting in simple mounting and good stability.

Still further, the fire distributing plate comprises a medium plate and inclined side plates located on two opposite sides, the medium plate and the side plates are of an integrally molded structure, the elongated protrusions are located on the side plates on both sides, and a plurality of heat conduction holes are provided on the medium plate. Arrangement of the plurality of heat conduction holes on a surface of the fire distributing plate results in better heat balance, and the food to be roasted to be heated evenly, resulting in better taste.

The present disclosure provides a grill shell structure for a grill, a heat insulation member is accommodated in an inner chamber, and the heat insulation member is fixed on a grill shell by a fixing structure. A support body is arranged between a side of the heat insulation member facing an inner wall of the inner chamber and the inner wall of the inner chamber for support so that the heat insulation member is arranged spatially apart from an inner wall of the grill shell to form a heat insulation chamber between the heat insulation member and the inner wall of the grill shell. The heat insulation member is arranged in a spaced apart manner from the grill shell through the support body, and the heat insulation chamber separates burning pellets in the inner chamber from the bottom of the grill shell, which can effectively slow down heat transfer, reduce temperature of the grill shell and extend service life of the grill shell.

### BRIEF DESCRIPTION OF THE DRAWINGS

FIG. 1 is an overall structural diagram of a grill shell structure for a grill of the present disclosure;

FIG. 2 is a structural diagram of a heat insulation member in the grill shell structure for a grill of the present disclosure;

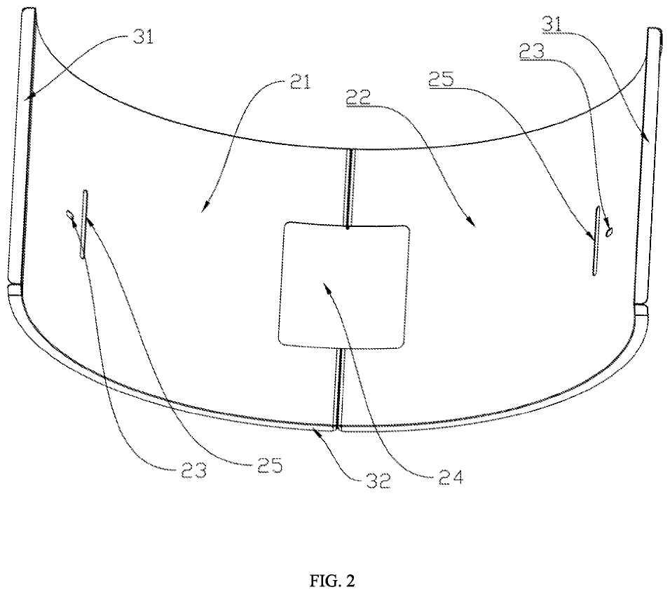

FIG. 3 is an exploded view of the grill shell structure for a grill of the present disclosure; and

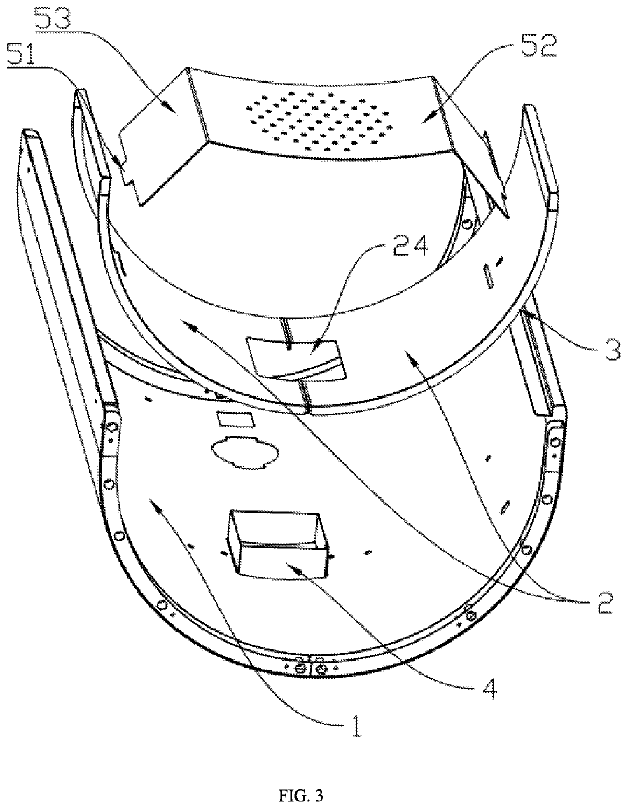

FIG. 4 is a structural diagram of a fire distributing plate in the present disclosure.

In the drawings: 1. grill shell; 2. heat insulation member; 21. first plate body; 22. second plate body; 23. first mounting hole; 24. perforation; 25. second mounting hole; 3. Support body; 31. first flange; 32. second flange; 4. ash falling pipe; 5. fire distributing; 51. elongated protrusion; 52. medium plate; 53. side plate; 54. heat conduction hole.

### DESCRIPTION OF THE EMBODIMENTS

A clear and complete description is provided to the technical schemes in embodiments of the present disclosure with reference to the accompanying drawings in the embodiments of the present disclosure. It is obvious that the described embodiments are only part rather than all of the embodiments of the present disclosure. All other embodiments obtained by those of ordinary skill in the art based on the embodiments of the present disclosure fall within the protection scope of the present disclosure.

It should be understood by those skilled in the art that in the present disclosure, terms “longitudinal, transverse, above, below, front, rear, left, right, vertical, horizontal, top, bottom, inner, outer” and the like indicate orientation or positional relationship based on the orientation or positional relationship shown in the accompanying drawings, and are intended only to facilitate and simplify the description of the present disclosure rather than indicating or implying that the device or element referred to must have a specific orientation, be constructed and operated in a specific orientation, and therefore the above terms should not be construed as limitation of the present disclosure.

### Embodiment 1:

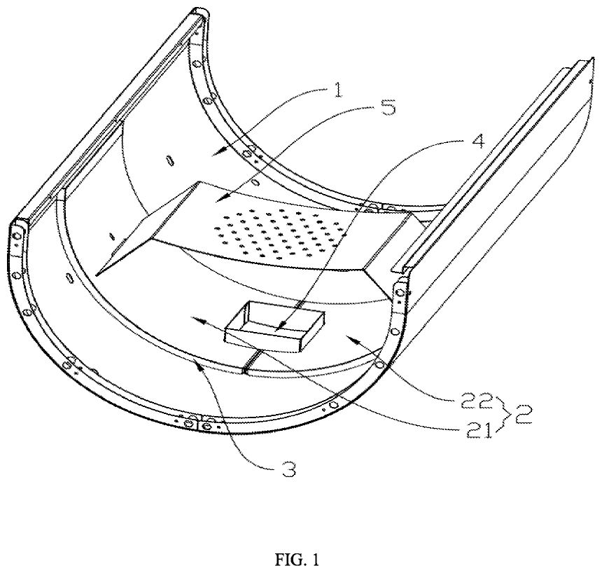

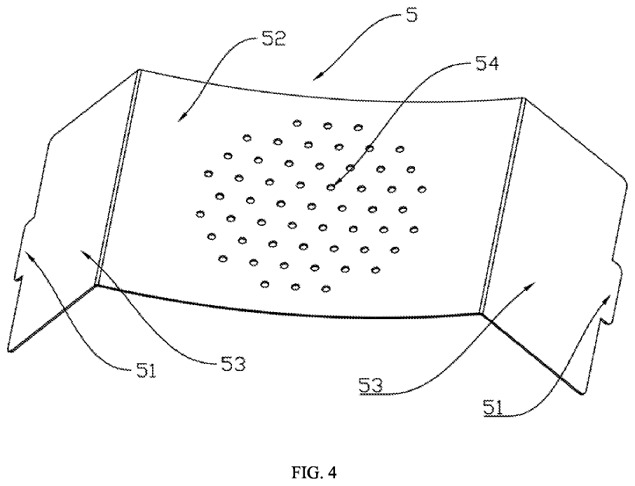

As shown in FIGS. 1 and 4, the present embodiment describes a grill shell structure for a grill, which comprises a grill shell 1. The grill shell 1 is of a semi-cylindrical shape, the grill shell 1 comprises an inner chamber, a heat insulation member 2 is accommodated in the inner chamber, and the heat insulation member 2 is fixed on the grill shell 1 by a fixing structure. The heat insulation member 2 is an arc-shaped plate which has a radian adapted to the grill shell 1. A support body 3 is arranged between a side of the heat insulation member 2 facing an inner wall of the inner chamber and the inner wall of the inner chamber for support, that is, the support body 3 is located between the heat insulation member 2 and the inner wall of the inner chamber so that the heat insulation member 2 is arranged spatially apart from an inner wall of the grill shell 1 to form a heat insulation chamber between the heat insulation member 2 and the inner wall of the grill shell 1 to separate burning pellets in the grill chamber from a bottom of the grill shell 1, and heat generated by pellet burning is conducted to the bottom of the grill shell 1 through the heat insulation member 2. The heat insulation chamber between the heat insulation member 2 and the grill shell 1 can effectively slow down heat transfer, reduce temperature of the grill shell 1 and extend service life of the grill shell 1.

Further, the support body 3 in the present embodiment is a flange on the heat insulation member 2, and the heat insulation member 2 can be provided with flanges on a set of opposite side edges, and the heat insulation member 2 can also be provided with flanges all around. In the present embodiment, a first flange 31 is formed on the heat insulation member at two opposite first edges, and a second flange 32 is formed on the heat insulation member at two opposite second edges, so that the heat insulation member 2 is arranged spatially apart from the grill shell 1 to form a heat insulation chamber. The first flange 31 and the second flange 32 have a height of 9 mm, so that the height of the heat insulation chamber is 9 mm, or the first flange 31 and the second flange 32 have a height of 10 mm, so that the height of the heat insulation chamber is 10 mm, or the first flange 31 and the second flange 32 have a height of 11 mm, so that the height of the heat insulation chamber is 11 mm.

Still further, the heat insulation member 2 comprises a first plate body 21 and a second plate body 22 distributed symmetrically, the heat insulation member 2 is formed by splicing the first plate body 21 and the second plate 22 body, then the heat insulation member 2 is of a split-type structure (in the present embodiment, it is formed by splicing, and can also be formed integrally, then the heat insulation member 2 is of an integral structure), first mounting holes 23 are provided on the first plate body 21 and the second plate body 22, and the first mounting holes 23 are symmetrically distributed on the first plate body 21 and the second plate body 22. In the present embodiment, the fixing structure is a bolt, and the first mounting holes 23 are waist-shaped holes, the bolt is connected to the grill shell 1 through the first mounting holes 23, and fixed with the grill shell 1 by a nut, so that the heat insulation member 2 is fixed on the grill shell 1.

Still further, a bottom of the grill shell 1 is provided with an ash falling pipe 4, the inner chamber of the grill shell 1 is provided with a combustion tank for placing fuel, the combustion tank is located directly above the ash falling pipe 4, and the ash falling pipe 4 can discharge ash generated by the combustion tank, thus temperature around the ash falling pipe 4 is relatively high; and two notches corresponding to a position of the ash falling pipe 4 are provided at a junction of the first plate bod_{y} 21 and the second plate body 22, the notches are symmetrically combined to form a perforation 24, and the ash falling pipe 4 is arranged through the perforation 24, size of the perforation 24 is adapted to the size of the ash falling pipe 4 for arranging the ash falling pipe 4 in a spaced apart manner, and the heat insulation member 2 can be positioned and arranged in the grill shell 1 through the notches and the ash falling pipe 4, resulting in more accurate and convenient mounting.

Still further, a fire distributing plate 5 located above the combustion tank is also accommodated in the inner chamber for balancing the heat resulting from pellet burning, so that the food to be roasted is evenly heated; and second mounting holes 25 are provided on the first plate body 21 and the second plate body 22, and the second mounting holes 25 are symmetrically distributed on the first plate body 21 and the second plate body 22, the second mounting holes 25 are elongated through holes, both sides of the fire distributing plate 5 are provided with elongated protrusions 51 adapted to the second mounting holes 25, and the elongated protrusions 51 are inserted into the second mounting holes 25 so that the fire distributing plate 5 is arranged on the heat insulation member 2.

Still further, the fire distributing plate 5 comprises a medium plate 52 and inclined side ₚlates 53 located on two opposite sides. The medium plate 52 and the side plates 53 are of an integrally molded structure, the medium plate 52 and the side plates 53 on two sides are in a trapezoid shape, the elongated protrusions 51 are located on the side plates 53 on two sides, and the fire distributing plate 53 is arranged in the grill chamber, resulting in better stability and heat balance. A plurality of heat conduction holes 54 are provided on the medium plate 52, and the plurality of heat conduction holes 54 are in a honeycomb shape, resulting in better heat balance, even heating of the food to be roasted and better taste.

The present disclosure describes a grill shell structure for a grill, a heat insulation member 2 is accommodated in an inner chamber, and the heat insulation member 2 is fixed on a grill shell 1 by a fixing structure. A support body 3 is arranged between a side of the heat insulation member 2 facing an inner wall of the inner chamber and the inner wall of the inner chamber for support so that the heat insulation member 2 is arranged spatially apart from an inner wall of the grill shell 1 to form a heat insulation chamber between the heat insulation member 2 and the inner wall of the grill shell 1. The heat insulation member 2 is arranged in a spaced apart manner from the grill shell 1 through the support body 3, and the heat insulation chamber separates burning pellets in the inner chamber from the bottom of the grill shell 1, which can effectively slow down the heat transfer, reduce the temperature of the grill shell 1 and extend the service life of the grill shell 1.

The present disclosure is not limited to the above-mentioned preferred embodiments, and any person can obtain other products in various forms under the suggestion of the present disclosure. However, regardless of any change in the shape or structure thereof, any technical scheme having the same or similar technical scheme as the present application falls within the protection scope of the present disclosure.

What is claimed is:

1. A grill shell structure for a grill, comprising a grill shell, the grill shell comprising an inner chamber, wherein a heat insulation member is accommodated in the inner chamber, and the heat insulation member is fixed on the grill shell by a fixing structure; and a support body is arranged between a side of the heat insulation member facing an inner wall of the inner chamber and the inner wall of the inner chamber for support so that the heat insulation member is arranged spatially apart from an inner wall of the grill shell to form a heat insulation chamber between the heat insulation member and the inner wall of the grill shell.

2. The grill shell structure for a grill according to claim 1, wherein a first flange is formed on the heat insulation member at two opposite first edges.

3. The grill shell structure for a grill according to claim 2, wherein a second flange is formed on the heat insulation member at two opposite second edges.

4. The grill shell structure for a grill according to claim 3, wherein the first flange and the second flange have a height of 10±1 mm, so that the height of the heat insulation chamber is 10±1 mm.

5. The grill shell structure for a grill according to claim 1, wherein the heat insulation member comprises a first plate body and a second plate body distributed symmetrically, and the heat insulation member is formed by splicing or integral molding of the first plate body and the second plate body.

6. The grill shell structure for a grill according to claim 5, wherein symmetrical first mounting holes are provided on the first plate body and the second plate body, and the fixing structure is connected to the grill shell through the first mounting holes, so that the heat insulation member is fixed on the grill shell.

7. The grill shell structure for a grill according to claim 5, wherein a bottom of the grill shell is provided with an ash falling pipe, two notches corresponding to a position of the ash falling pipe are provided at a junction of the first plate body and the second plate body, the notches are symmetrically combined to form a perforation, and the ash falling pipe is arranged through the perforation.

8. The grill shell structure for a grill according to claim 5, wherein a fire distributing plate is also accommodated in the inner chamber, the fire distributing plate is arranged on the heat insulation member, symmetrical second mounting holes are provided on the first plate body and the second plate body for connecting the fire distributing plate, and the second mounting holes are elongated through holes.

9. The grill shell structure for a grill according to claim 8, wherein the fire distributing plate is provided with elongated protrusions on both sides for connecting the heat insulation member, and the elongated protrusions of the fire distributing plate are inserted into the second mounting holes to connect the heat insulation member.

10. The grill shell structure for a grill according to claim 9, wherein the fire distributing plate comprises a medium plate and inclined side plates located on two opposite sides, the medium plate and the side plates are of an integrally molded structure, the elongated protrusions are located on the side plates on both sides, and a plurality of heat conduction holes are provided on the medium plate.
